(19) United States
(12) Patent Application Publication
(10) Pub. No.: US 2015/0286757 A1
(43) Pub. Date: Oct. 8, 2015

(54) Method for Efficiently Predicting the Quality of Additively Manufactured Metal Products

(71) Applicant: Shi-chune Yao, Pittsburgh, PA (US)

(72) Inventor: Shi-chune Yao, Pittsburgh, PA (US)

(21) Appl. No.: 14/667,939

(22) Filed: Mar. 25, 2015

Related U.S. Application Data
(60) Provisional application No. 61/995,138, filed on Apr. 4, 2014.

(51) Int. Cl. G06F 17/50; G06F 17/10

(52) U.S. Cl. CPC G06F 17/5009; G06F 17/10

(57) ABSTRACT

This invention is focused on a new method of numerical modeling of the Direct Metal Additive Manufacturing process with the layer-by-layer building of the metal products. This method separates the global macro-scale modeling and the local micro-scale modeling, with a database to link in between. The database containing the micro-scale modeling results can be established well before the global scale product simulation is conducted. As a result, this invention only uses the global modeling and database to simulate the additive manufacturing of the whole product, without using the time-consuming micro-scale modeling simultaneously. This new method enables very rapid simulation of the additive buildup process of products and prediction of product qualities, which only takes minutes to complete the simulation instead of weeks needed by the conventional methods of simulation known to those skilled in the art.

### CROSS-REFERENCE TO RELATED APPLICATIONS

This application claims priority to U.S. Provisional Application Ser. No. 61/995,138, titled Method for Efficient Numerical Simulation of Additive Manufacturing of Metal Products, filed Apr. 4, 2014, incorporated by reference herein in its entirety.

### STATEMENT REGARDING FEDERALLY-SPONSORED RESEARCH AND DEVELOPMENT

Not Applicable

### FIELD OF THE INVENTION

This patent addresses the numerical method for predicting the quality of metal products through layer-by-layer additive manufacturing process using point heat sources such as laser or electron-beam. This invention describes a new method of performing the simulation to significantly reduce the computation time that the simulation is able to predict the outcome quickly, and enable the improved process design and quality of metal products.

### BACKGROUND

Direct Metal Additive Manufacturing (DMAM) applies the metal powder by spreading a layer or spraying directly on solids, and applies a point heat source of laser or electron-beam at selected locations to melt the powder onto the partially made products. Then, another layer of metal is added on top of this layer. As shown in FIG. 1 for a typical case of using powder bed, the metal product is therefore manufactured additively layer by layer. The significant challenges of product qualities are the distortions or fracturing as well as the undesirable micro-structures of the products, arising from significant residual stress and uncontrolled phase transformation during freezing and cooling.

When the point heat source applied to the powder or solid surface a molten metal pool is formed. The local freezing process of the melt pool could determine the local crystalline structure of the material. When the molten pool starts to freeze there is no stress, but the surrounding metal is at a temperature much below the molten temperature of the freezing pool. After the product is eventually cooled to the room temperature, the material in the previous pool region experiences much more temperature drop than its surrounding metals, and more reduction of density occurs in the previous pool region due to the presence of the thermal expansion coefficient. Due to the uneven shrinkages, thermal stress occurs.

On the other hand, due to the repeated building of the thin layers at the top, the material at a location of a particular layer experiences heating-cooling cycles repeatedly in time, with each temperature peak lower than the one before due to the increased distance of the top layer during the buildup. The phase of the material at this point is transformed continuously in the heating-cooling cycles until the temperature excursion of a cycle is too low to cause the phase transformation. The resulting final microstructure is then determined, but may not be desirable.

Usually, the industry practice takes several trials of fabrication to have a good product developed. As such, new approaches are required to mitigate and control the product distortions and microstructures. The ability to predict the process characteristics before production will allow minimizing or completely eliminating distortions and provide desirable microstructure. Presently, the primary means available to those skilled in the art are using empirically based process maps or simple guidelines with limited capabilities. Numerical simulation of the total process of DMAM will enable the prediction of thermal distortions and microstructures at any location of parts and enables the identifying of process conditions that would lead to a better product. It is also expected that the simulation model will be applicable for all metal products when appropriate material properties are applied.

The DMAM process involves the sweeping of a point heat source of laser or e-beam in the form of a line or continuous dots to a layer of metal powder on solid surface, where the molten powder metal merges with the previous layer of product at below. A typical case of applying a line sweeping laser on a powder layer placed on solid surface is shown in the FIG. 2 (with mm as unit). This particular type of process will be used to make specific descriptions in the explanations of this patent.

Generally, the process parameters involved in DMAM are at both the local and global levels. The local parameters, which are located near the point heat source, are typically the material, the powder sizes, the layer thickness, the heat source power, size, and speed, and the local initial solid temperature before the heat is applied. On the other hand, the global parameters of the process are the point heat source sweeping pattern as well as the already built structures under the layer and its cooling process. Since the local residual stress is controlled by the properties of the molten pool and its cooling process, which are influenced by both the local and global process parameters, the local and global process simulation are well coupled and need be conducted simultaneously. Furthermore, the local and global process and phenomena could be numerically modeled together based upon the first principles.

The critical problem of the process simulation is the computational time involved. The coupled thermal and stress modeling are performed simultaneously on the global and local scales. The local micro-scale modeling near the point heat source requires very fine meshes and very small time steps (in the order of micro-meter and mili-seconds), but has to cover all the locations on each layer and all the layers of a product (in the order of centi-meter and minutes). The schematic of the local and global meshes is shown in FIG. 1.

Typically, for a single trace of heat source with 300 micron width traveling for a 2 mm distance on a 30 micron thick powder layer, the required computation time is in the order of half hour. For a small product of 1 cm cube, which involves 333 layers, each layer contains 33 traces, and the length of each trace is 1 cm, the computation time could be 27,472 hours (1,144 days), which is impossible to be performed even with a much faster computer. Therefore, the previously described modeling methods, known to those skilled in the art, are only able to simulate a small region of the production process [1] or been used to provide a design guide such as process map, based upon a few traces, indicating the permitted and disallowed domains of operations [2].

The present invention of a new modeling method will be able to reduce the computation time drastically to a very short time (order of an hour), and simulates the complete product building process of DMAM that the extent of deformation and microstructure [3] at exact locations can be predicted. Accordingly, the modification of the fabrication process to correct these predicted problems can be identified precisely. As a result, the quality of the metal product can be improved effectively and efficiently.

### BRIEF SUMMARY OF THE INVENTION

In this invention, the local modeling and the global modeling are separated. Before the production simulation, the local modeling, such as a single or several traces, will be performed in advance for selected conditions and the results of local residual stress and crystalline structure etc. are stored in a database. Since the local phenomena of heating, melting and cooling processes in building a metal product are very much repeated, as shown typically in the FIG. 3, the needed database will be limited in size. During the production simulation, the global thermal modeling is performed first and providing the initial local solid temperatures of the product before the point heat source is applied. Then, using the set of local parameters, the production simulation retrieves the proper local residual stress from the database, at location by location, to cover the whole product, without performing the local modeling again. The computation of production simulation is therefore conducted all with large meshes and at long time-steps in the global scale, without conducting the time consuming local modeling at the same time. As a result, the production simulation is very rapid.

### BRIEF DESCRIPTION OF THE DRAWINGS

FIG. 1. FIG. 1 shows the schematic of a typical DMAM process and the local and global meshes.

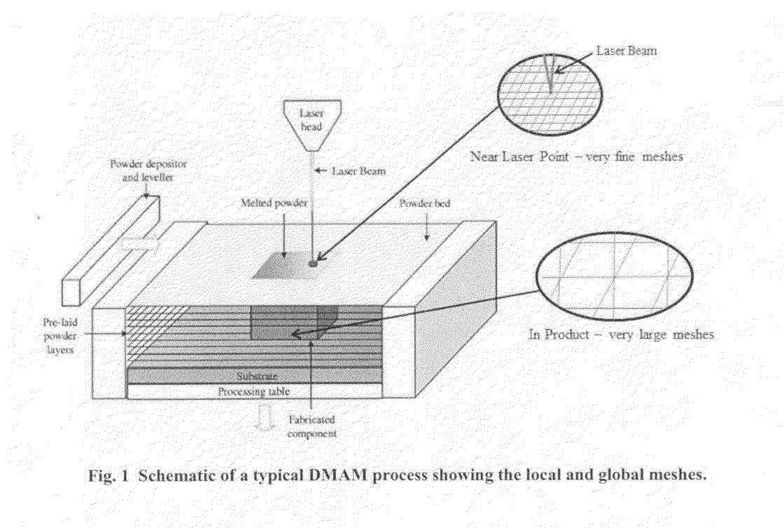

FIG. 2. FIG. 2 shows the local DMAM process with a moving heat source on the metal powder layer to form a molten pool and then cooling down by surrounding. Units are in mm.

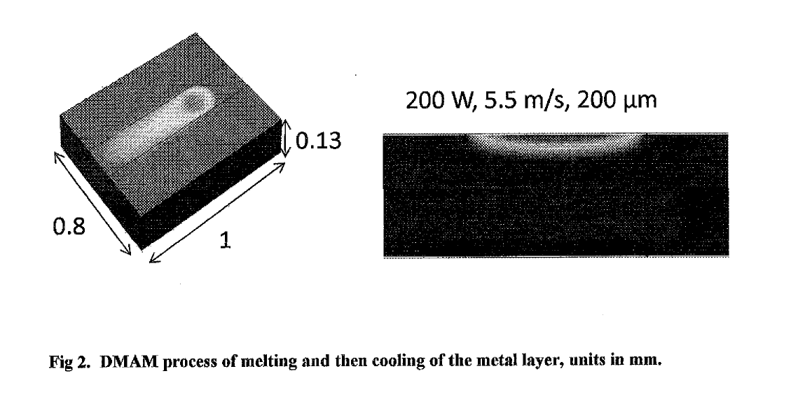

FIG. 3. FIG. 3 illustrates the final residual stresses induced by the solidified molten pools along the parallel heat traces on layers of formed metal.

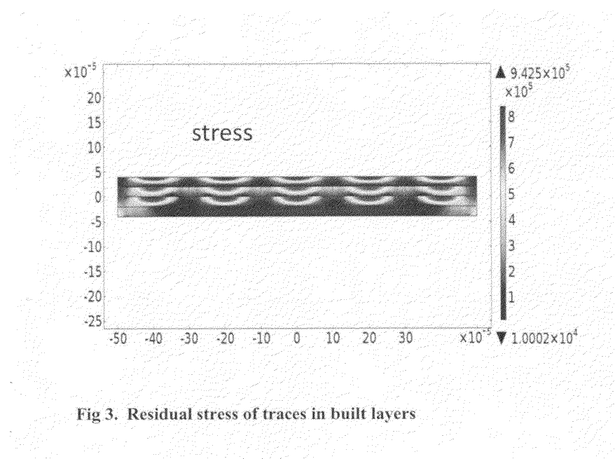

FIG. 4. FIG. 4 presents the flow chart of the modeling method, where the global modeling and local micro-scale modeling are separated with a database.

### DETAILED DESCRIPTION AND BEST MODE OF IMPLEMENTATION

### Overall Architect

This invention separates the global modeling and local modeling by decoupling their relationship through a database. The global model uses large computational meshes and large time steps, while the local model uses very small computational meshes and very short time steps. In between, a database is used to provide the pre-calculated local results to the global evaluation. In contrast, conventionally known to those skilled in the art, the global and local models are conducted simultaneously that the overall number of meshes is exceedingly huge to satisfy hundreds layers, tens traces each layer, tens point heat source diameter in each trace, tens of meshes around each point heat source area, and to perform both thermal and stress analyses together. As a result, the computational time is extremely long. In fact, this invention is able to complete a simulation in minutes as compared with the conventional method of taking weeks or months.

This invention allows for the local micro-scale modeling conducted before the global modeling is performed for limited number of cases. The local information is stored in the database, and at a later moment the needed information can be retrieved rapidly from the database. Therefore, the global modeling of the additive layer-by-layer manufacturing of the product can be conducted, using the database, totally with large mesh and large time steps, without performing local modeling simultaneously, to provide a very fast simulation.

This invention uses a database to store local information and to provide needed information to the global modeling of product simulation. A database can serve this function is because the local phenomena of heating, melting, solidifying, and cooling are controlled by limited number of local parameters. Although typical local parameters are the material, powder sizes, layer thickness, point heat source power (laser or e-beam), diameter, and speed, and the local solid temperature before local heating is applied; however, in most applications only 2 to 3 parameters are varied in a production process. Typical major parameters are the local laser speed and local solid temperature. Furthermore, in general the local processes are identical and repeated. As a result, the use of a database is feasible and effective.

### Flow Chart

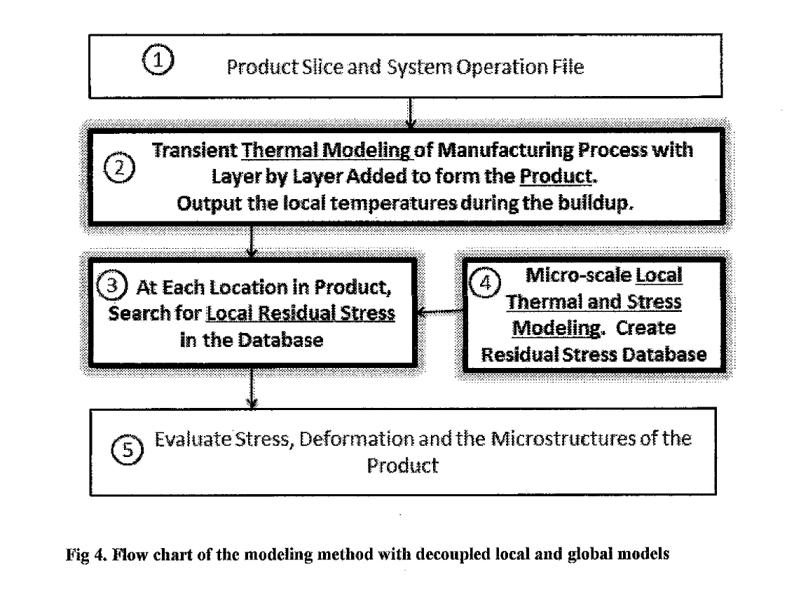

This invention is shown in FIG. 4 for the overall flow chart. In the reference 1, the 3D product configuration is sliced into layers and the intended operation of laser is planned. This can be an input file generated from other software by the user. Then, in 2, the global modeling of the transient thermal process of the buildup of product is performed, where each layer of the product is evaluated considering the partially-built product below this layer. Since the time step is large (order of second), the rapid local melting and freezing (order of ms) under the point heat source is considered as a heat source. The main result of 2 is the local initial solid temperature before the laser is applied, for every location in the product. Also, if needed, the temperature-time histories at selected locations can be obtained. The result of 2 is sent to the database search 3, where the local residual stresses and crystalline structure at every position in the product are retrieved from database 4, according to the local temperature obtained from 2. The database in 4 is established from a separate local micro-scale modeling, which is performed before this production simulation. The local modeling has been a coupled thermal and stress evaluation using fine meshes and at short time scale. The residual stress and temperature-time histories of the product from 3 and 2 respectively are used in the global modeling 5 for the evaluation of the deformation, fracturing and microstructure of the product.

### REFERENCES

1. Yin, H., Wang, L., and Felicelli, S. D., “Comparison of Two-dimensional and Three-dimensional Thermal Models of the LENS Process,” Journal of Heat Transfer, Vol. 130, 102101-1, October 2008.
2. Beuth, J., Flanagan, H. L., “Process Mapping of Melt Pool Geometry,” International Patent Application No. PCT/US2012/048658, Pub. No. WO/2013/019663.
3. J. Sieniawski, W. Ziaja, K. Kubiak, and M. Motyka, “Microstructure and Mechanical Properties of High Strength Two-Phase Titanium Alloys,” TITANIUM ALLOYS-ADVANCES IN PROPERTIES CONTROL, Chapter 4, ISBN 978-953-51-1110-8, 2013.

What is claimed is:

1. A method for efficient numerical simulation of additive manufacturing of metal products comprising:
a global macro-scale modeling,
a local micro-scale modeling, and
a database.

2. The method of claim 1, wherein the global modeling uses large meshes to cover the whole product and large time steps to cover the whole duration of building the product.

3. The method of claim 1, wherein the local micro-scale modeling uses very small meshes and very small time scale to cover the local heating, melting, freezing and cooling processes.

4. The method of claim 1, comprise the establishing the database, and the using of the database.

5. The method of claim 2, wherein the global modeling addresses the thermal process during the build of product layer by layer.

6. The method of claim 3, wherein the local micro-scale modeling provides results and stored in the database, prior to the conduct of the global macro-scale modeling of building the product.

7. The method of claim 4, wherein the database is used in the additive manufacturing simulation performed by the global modeling, without the conduct of local micro-scale modeling simultaneously, to achieve a rapid simulation time.

8. The method of claim 5, wherein the transient heat transfer is evaluated for a layer of powder together with the structure of the partially-built product under this layer, and subsequently for all the layers, without the detailed micro-scale evaluation of the fast melting and freezing processes under the heat source.

9. The method of claim 5, wherein the main result of global modeling is the temperature of the solid under the heat source for every position during the construction, and the temperature time histories in the product during construction.

10. The method of claim 6, wherein the transient heat transfer together with thermal stress and local crystalline structure are evaluated for the local heating, melting, freezing and cooling processes.

11. The method of claim 6, wherein the result of the local modeling is stored in the database before the global modeling of product manufacturing is conducted.

12. The method of claim 7, wherein the search method in the database could be the inter or extra-polation of data sets, reading curves, functions, or multi-dimensional surfaces, or using advanced methods such as artificial neural networks or fuzzy logics etc.

13. The method of claim 7, wherein the local residual stress distribution from database is used to evaluate the product deformation and fracturing, wherein the local temperature-time histories in the product are used with the material phase diagram to evaluate the microstructures.
